(19) United States
(12) Patent Application Publication
(10) Pub. No.: US 2025/0079744 A1
(43) Pub. Date: Mar. 6, 2025

(54) LOADBREAK CONNECTOR SAFETY SHEATH

(71) Applicant: Double Z Safety, LLC, Oregon City, OR (US)

(72) Inventor: Nicholas Gonzalez, Oregon City, OR (US)

(21) Appl. No.: 18/787,337

(22) Filed: Jul. 29, 2024

Related U.S. Application Data
(60) Provisional application No. 63/579,294, filed on Aug. 28, 2023.

(51) Int. Cl. H01R 13/46; H01R 13/50; H01R 13/516; H01R 13/633

(52) U.S. Cl. CPC H01R 13/465; H01R 13/50; H01R 13/516; H01R 13/6335

(57) ABSTRACT

Loadbreak connector safety sheath, and related methods, the safety sheath being adapted for partially housing a loadbreak connector for a lateral access contact of a power distribution system, the safety sheath further providing a safety sheath pull ring and an attachment member for attaching lockout safety and warning tags, the safety sheath comprising an outer sheath member adapted for covering a loadbreak connector pull ring of the loadbreak connector otherwise accessible for pulling the loadbreak connector off of an energized lateral access contact in accordance with safety protocols, and means, such as a narrowed channel formed integrally within the safety sheath adapted to conform to a contour of the loadbreak connector, for securely retaining the outer sheath member on the loadbreak connector.

### CONTINUITY AND CLAIM OF PRIORITY

This is an original U.S. non-provisional patent application depending upon and claiming the benefit and priority of a original U.S. provisional application Ser. No. 63/579,294, filed on Aug. 28, 2023.

### FIELD

The invention relates to safety devices and methods for tagging of loadbreak connectors in high-voltage environments, and more particularly the invention relates to an improved device and improved method adapted for improving the reliability of a device and method for tagging of loadbreak connectors in medium-voltage level (15 kV to 25 kV) environments such that risk of miscommunication and injuries and death associated with accidental discharge via human or other unwanted contact are reduced.

### BACKGROUND

Loadbreak connectors play a crucial role in isolating faults and protecting electrical equipment and are primarily used for isolation, load switching, fault isolation, load transfer, sectionalizing, and occasionally voltage regulation. During the maintenance of a power distribution system, such as for example a medium voltage level (15 kV to 25 kV) power distribution system, a loadbreak connector may be disconnected from the lateral (connection contact) to de-energize the connected segment of the line and ensure the safety of line workers in a disconnected segment of the power distribution system. Prior loadbreak connectors have included a loadbreak connector pull ring, as is known in the art, to have enabled access to the loadbreak connector, preferably by a hot-stick adapted for enabling safe removal of the loadbreak connector from the lateral.

Lockout tagging involves devices and processes designed to be used for safety purposes, wherein lockout tags are attached to one or more loadbreak connectors to indicate that maintenance is taking place on the line and to provide instructions not to reconnect the loadbreak connector(s) so that local workers and other persons working elsewhere on the line are not accidentally exposed to deadly voltage levels. The lockout/tagout procedure is designed to ensure that the disconnected line is physically locked and tagged with a warning sign, indicating that maintenance work is in progress. Only the line worker signing the lockout tag can release the line for reconnection. This procedure prevents unauthorized access or connection of the disconnected line while it is being serviced.

Of course, there are many situations where maintenance and repairs become needed on power distribution lines. For example, severe weather conditions, such as lightning, hurricanes/cyclones/typhoons, tornados, other winds, floods, or freezing, cause damage to power distribution lines which in turn causes power outages. This necessitates line workers needing to be working on one or more de-energized power distribution lines.

Unfortunately, prior lockout tags have become unattached from the loadbreak connectors. And if a loadbreak connection tag has thus been lost, or a lockout procedure has otherwise not been followed, and the loadbreak connector has been reattached to an energized lateral connection contact while maintenance is in process downline, the line being handled by line workers in a nearby location has become energized, causing great danger, significant injury, and oftentimes death, to line workers.

Thus, there has been needed an improved device and improved methods to further prevent the accidental reconnection of a loadbreak connector to its corresponding energized lateral connection contact.

### SUMMARY

In accordance with an aspect and embodiment of the disclosure, there is provided a loadbreak connector safety sheath adapted for partially housing a loadbreak connector for a lateral access contact of a power distribution system. The safety sheath comprises: an outer sheath member adapted for covering a loadbreak connector pull ring of the loadbreak connector otherwise accessible for pulling the loadbreak connector off of an energized lateral access contact in accordance with safety protocols, a safety sheath pull ring for attaching and detaching the safety sheath from the loadbreak connector using a hot-stick, and means, such as a retaining member, for retaining the outer sheath member on the loadbreak connector.

In accordance with another embodiment, there is provided a loadbreak connector safety sheath adapted for partially housing a loadbreak connector for a lateral access contact of a power distribution system, the safety sheath, comprising an outer sheath member adapted for covering a pull ring of the loadbreak connector otherwise accessible for pulling the loadbreak connector off of an energized lateral access contact in accordance with safety protocols.

The loadbreak connection safety sheath in accordance with this embodiment further comprises a safety sheath pull ring for attaching and detaching the safety sheath from the loadbreak connector using a hot-stick. Still further, the safety sheath comprises means, such as a retaining member, for retaining the outer sheath member on the loadbreak connector, and an attachment member on the outer sheath and adapted for receiving a lockout warning tag.

In each embodiment of the safety sheath of the disclosure, the means for retaining the outer sheath member on the loadbreak connector may comprise a narrowed channel integrated internally of the outer sheath member and adapted for flexibly conforming to a contour portion of the loadbreak connector to securely hold the outer sheath member on the loadbreak connector. Further, in each embodiment, the narrowed channel may form a clip for holding the outer sheath member on the loadbreak connector. Still further, in each embodiment, the means for retaining the outer sheath member on the loadbreak connector may do so to the degree of requiring at least four pounds of pulling pressure to remove the outer sheath member from the loadbreak connector.

Alternative means for retaining the outer sheath member on either embodiment of the loadbreak connector, may comprise a strap secured, as for example with hook and loop technology, or snaps, extending around a body portion of a loadbreak connector.

The safety sheath in accordance with either embodiment of the disclosure further preferably comprises an attachment area, also known as an attachment member, such as a metal or plastic ring, adapted for receiving a lockout warning tag. The lockout warning tag may be zip-tied, wire-tied, or otherwise attached to the attachment member. The attachment member preferably comprises, in either embodiment, an integrally molded ring portion located at an upper rear, i.e., posterior, portion of the outer sheath member of the safety sheath.

Further, the safety sheath pull ring in accordance with either embodiment of the disclosure is preferably located on the outer sheath member of the safety sheath at an upper rear, i.e., posterior, portion of the outer sheath member of the safety sheath adapted to allow safe access to remove the safety sheath from the loadbreak connector using, for example, a hot-stick.

The safety sheath outer sheath member of either embodiment of the disclosure is preferably comprised of one of PVC, PET, and ABS plastic.

In accordance with another aspect of the disclosure, there is provided an improved method of preventing accidental reconnection of a loadbreak connector while following safety protocols while maintenance is being performed on power lines, comprising the steps of:
A. Safely removing a loadbreak connector from an energized lateral connection contact of a power distribution system by pulling a pull ring of the loadbreak connector with an insulated hot-stick, or otherwise de-energizing a power line to be worked on;
B. Safely, for example by properly using an insulated hot-stick, and securely attaching a loadbreak connector safety sheath to the loadbreak connector to prevent access to the loadbreak connector pull ring to discourage reattachment of the loadbreak connector, or to otherwise prevent re-energizing of a power line that is being worked on, by an unauthorized person while maintenance is in progress; and
C. Securely installing a lockout tag on the safety sheath identifying safety information for the power line and the only responsible party certified to re-connect the loadbreak connector to an energized contact on the lateral of the power distribution system, or to otherwise restore power to the line.

In accordance with another embodiment of the method of this aspect of the disclosure, the method further comprises an inserted step of 1) attaching the loadbreak connector to a non-powered parking location of the lateral (either between steps A and B above, between steps B and C above, or after step C above).

In accordance with another aspect of the disclosure, the foregoing methods further comprise the steps of D) an authorized person-in-charge verifying clearance of workers from the line by direct personal contact via phone or radio, E) removing the safety sheath and lockout tag from the loadbreak connector safely, as by properly using an insulated hot-stick to pull on the safety sheath pull ring, and F) reattaching the loadbreak connector to an energized lateral connection contact safely, as by using an insulated hot-stick for accessing the loadbreak pull ring, or otherwise re-energizing the power line.

In accordance with the another embodiment in accordance with this aspect of the disclosure, the method further comprises the steps of D) an authorized person-in-charge verifying clearance of workers from the line by direct personal contact via phone or radio, E) removing the safety sheath and lockout tag from the loadbreak connector by using an insulated hot-stick to pull on the safety sheath pull ring, and F) safely removing the loadbreak connector, for example by properly using an insulated hot-stick, from the non-powered parking location of the lateral and further using the insulated hot-stick for replacing the loadbreak connector onto the energized lateral connection contact of the lateral, or otherwise re-energizing the power line.

Thus, the present device and methods are adapted for securely attaching a safety sheath to, and at least partially housing with the safety sheath, a loadbreak connector for a lateral access contact of a power distribution system, the safety sheath providing its own safety sheath pull ring and a safety sheath attachment member for attaching lockout safety and warning tags. Thus, the safety sheath device helps secure the messaging intended by attachment of lockout tags to loadbreak connectors. Further, it also requires extra carefully contemplated and deliberate steps, deliberate in part because preferably there will be required a significant pull or other force to remove the safety sheath from the loadbreak connector. This, in turn, encourages carefully considering the purpose of installation of the safety sheath, and the lockout tag information on the safety sheath, before removal of the lockout tag and the safety sheath (preferably using a hot-stick, removal of the safety sheath and the tag to be performed by policy only by an authorized person in charge, and using an insulated hot-stick to deliberately move the loadbreak connector to an energized connection contact of a lateral of a power distribution system. In this way, if a lockout safety and warning tag were to become detached from the safety sheath, at a minimum the safety sheath would still be present to cover the pull-ring of the loadbreak connector, thus preventing detachment/attachment of the loadbreak connector using a hot-stick, and the safety sheath would also in such case still serve to alert authorized personnel as to a missing lockout tag, which could thereby prevent injury and save lives of downline workers.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings, wherein like reference characters refer to like elements.

### BRIEF DESCRIPTIONS OF DRAWINGS

FIG. 1A is a side view illustration of an existing, prior, loadbreak connector;

FIG. 1B is a rear view illustration of the loadbreak connector of FIG. 1A;

FIG. 1C is a front view illustration of the loadbreak connector of FIGS. 1A and 1B;

FIG. 2A is a rear perspective view illustration of a loadbreak connector safety sheath in accordance with an aspect of the disclosure;

FIG. 2B is a a front view perspective view illustration of the loadbreak connector safety sheath of FIG. 2A;

FIG. 3A is a rear perspective view illustration of a loadbreak connector safety sheath of FIGS. 2A and 2B and having a lockout tag securely attached thereto;

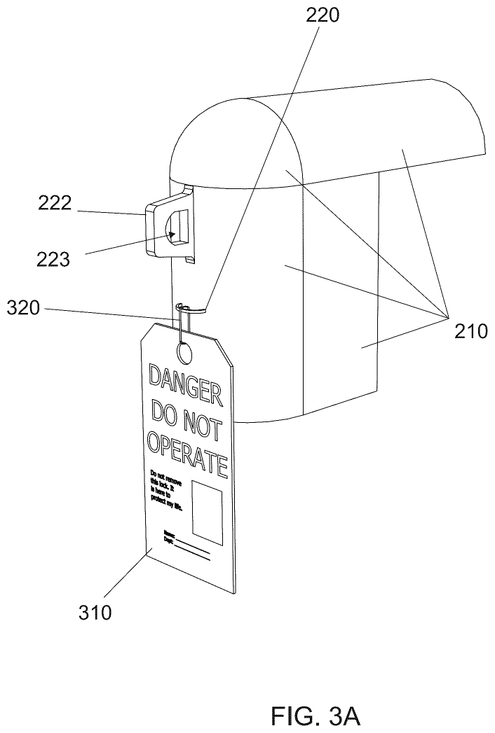

FIG. 3B is a front perspective view illustration of the loadbreak connector safety sheath and attached lockout tag of FIG. 3A;

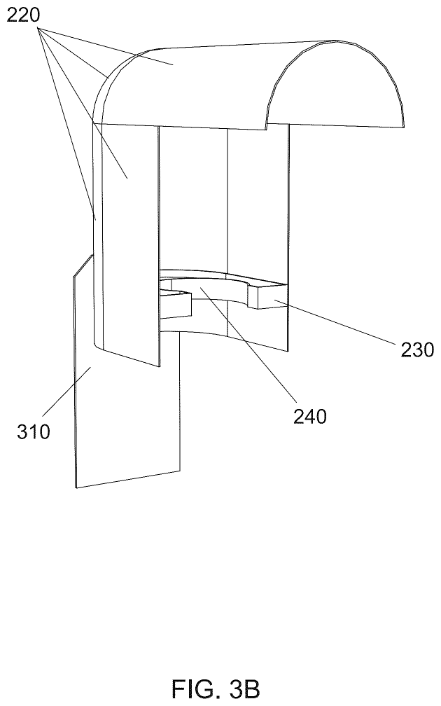

FIG. 4A is a rear perspective view illustration of a loadbreak connector safety sheath and attached lockout tag, showing the safety sheath installed on a loadbreak connector;

FIG. 4B is a front perspective view illustration of the loadbreak connector safety sheath and attached lockout tag installed on a loadbreak connector of FIG. 4A;

FIG. 4C is a side view illustration of the loadbreak connector safety sheath and attached lockout tag installed on a loadbreak connector of FIGS. 4A and 4B;

FIG. 4D is a rear-view illustration of the loadbreak connector safety sheath and attached lockout tag installed on a loadbreak connector of FIGS. 4A-4C;

FIG. 4E is a rear-view illustration of an alternative embodiment loadbreak connector safety sheath having an attached lockout tag and installed on a loadbreak connector;

FIG. 5A is a rear perspective view (using the same projection orientation as described above in connection with the other figures) of existing, prior, multiple lateral connection contacts for a power distribution system;

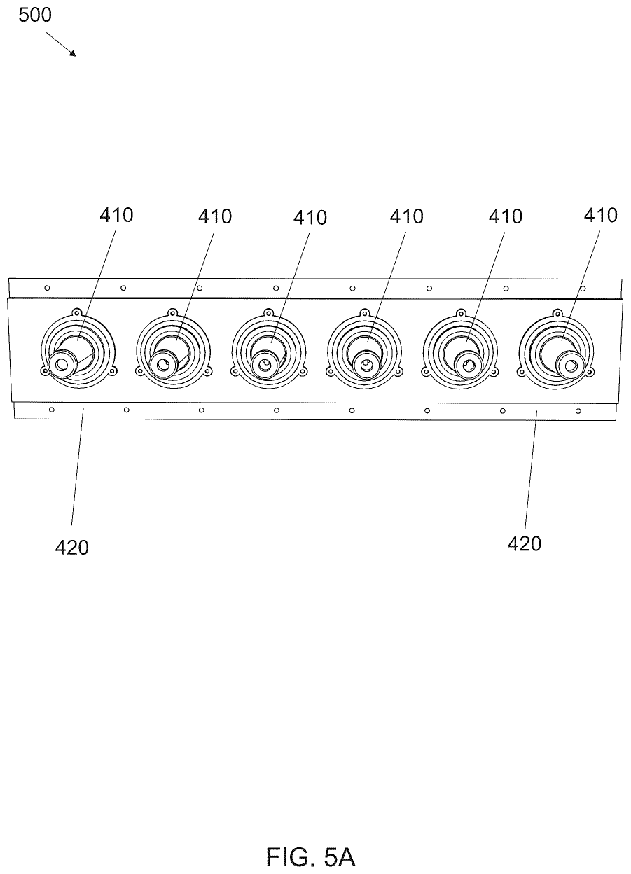

FIG. 5B. is a rear perspective view of the multiple lateral connection contacts for a power distribution system of FIG. 5A and showing a plurality of existing, prior, loadbreak connectors attached to a corresponding plurality of more central connection contacts;

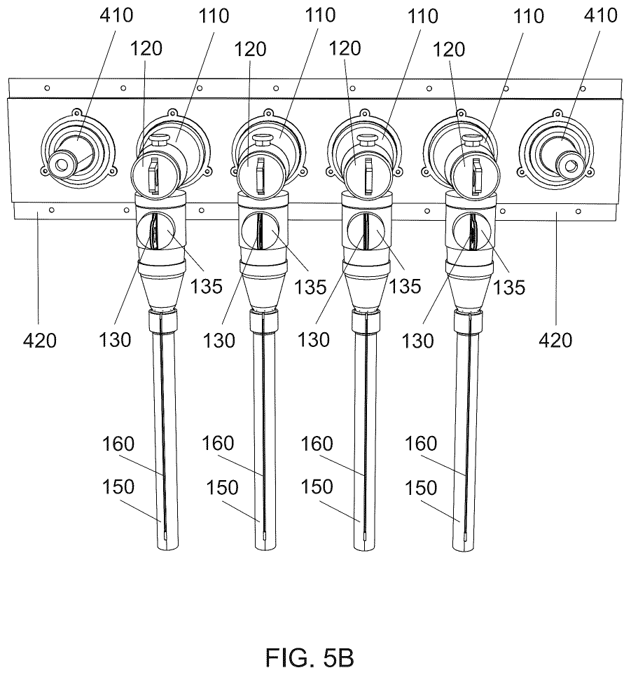

FIG. 5C is a rear perspective view of the multiple lateral connection contacts for a power distribution system of FIGS. 5A and 5B, having the plurality of loadbreak connectors attached to the corresponding plurality of more central connection contacts, and showing a plurality of loadbreak connector safety sheaths and attached lockout tags, installed on the three rightmost loadbreak connectors indicating three non-energized connection contacts for the power distribution system;

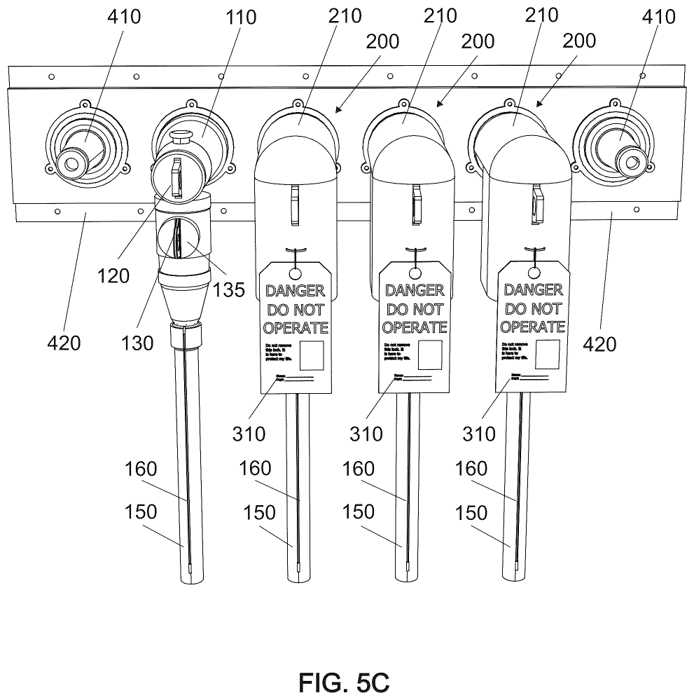

FIG. 6 is a flowchart showing method steps in accordance with an aspect and embodiment of the disclosure;

FIG. 7 is a flowchart showing method steps in accordance with another aspect and embodiment of the disclosure;

FIG. 8 is a flowchart showing method steps in accordance with another aspect and embodiment of the disclosure; and

FIG. 9 is a flowchart showing method steps in accordance with another aspect and embodiment of the disclosure.

### DETAILED DESCRIPTION

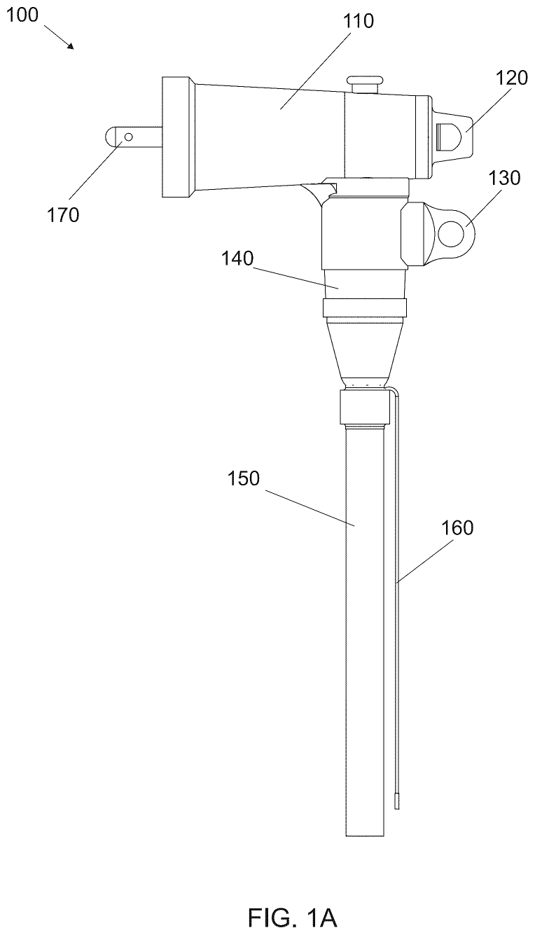

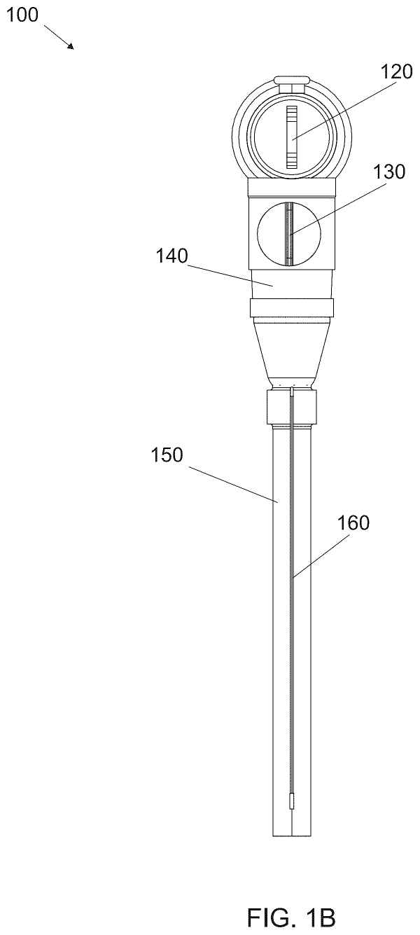

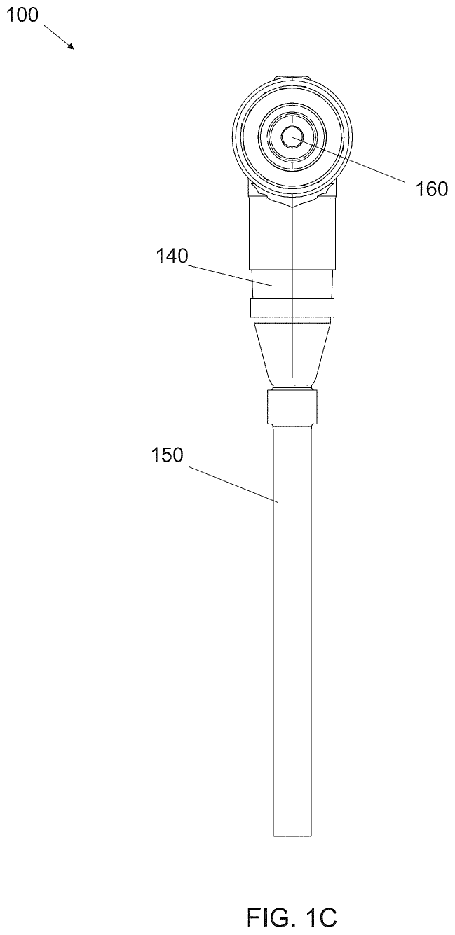

Referring to FIGS. 1A-C and 5A-C, there are shown different views of a typical lateral power distribution panel 420 having typical power connection contacts 410, and wherein typical loadbreak connectors 100 serve to connect the lateral to medium voltage power distribution lines 150. Each loadbreak connector 100 typically comprises an axial housing 110 partially surrounding a plug connection member 170 for making contact with power distribution circuitry behind the lateral power distribution panel. The loadbreak connectors' 100 axial housing members 110 each further comprises a posterior loadbreak connector pull ring 120 attached to, or integral with, the axial housing, to allow removal and handling of the loadbreak connector with an insulated hot-stick as is known in the art. Each loadbreak connector 100 also typically comprises a transverse housing 135 typically having a narrowed neck portion 140. An insulated power distribution line 150 is attached to the plug connection member 170 within the axial housing 110 through an end portion 145 of the transverse loadbreak connector housing 135, and there is also provided a ground wire 160 attached as known near the end portion 145. Each loadbreak connector transverse housing 135 further provides a capacitive test contact 130, for attaching lockout warning tags 310 to these prior loadbreak connectors 100, for testing whether the distribution line associated with the loadbreak connector 100 is energized or not and an additional ground contact 115 for securing a ground connection around the loadbreak connector.

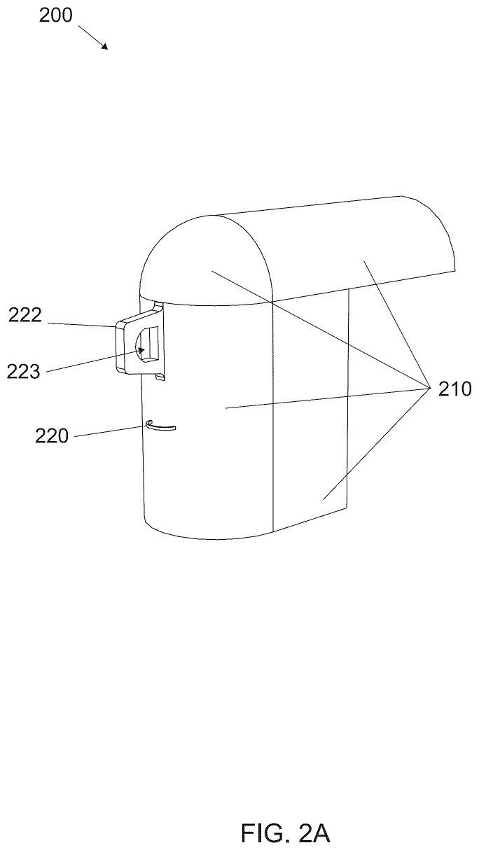

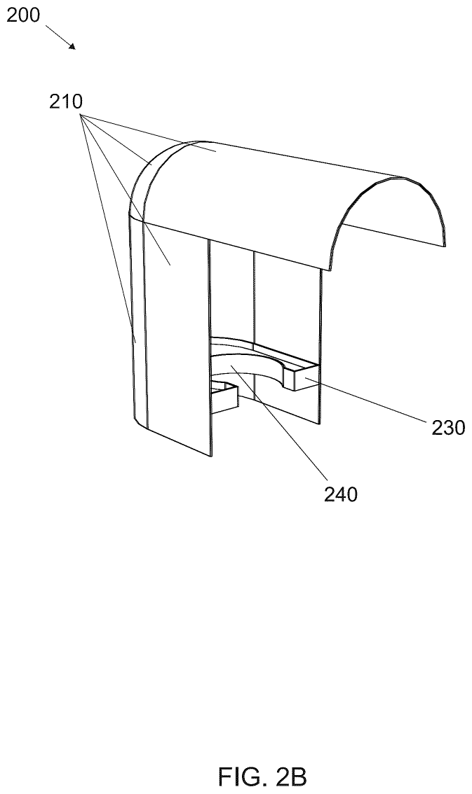

Referring additionally to FIGS. 2A-B, 3A-B, and 4A-E, there is shown a loadbreak connector safety sheath 200, adapted for partially housing a loadbreak connector 100. The loadbreak connector safety sheath 200 comprises preferably an integral outer sheath member 210—preferably integral in the sense that it is comprised of one piece of material. The preferably integral outer sheath member is comprised of an upper portion 212, an upper posterior portion 214, a rear portion 216, and side portions 218, 219). Again, while these portions 212, 214, 216, 218, 219, are all preferably one unitary outer sheath member 210, the sheath member may be thought of as comprising a plurality of panel portions as described.

There is preferably provided a safety sheath pull ring 222 defining a hole 223 therein, and there is further provided an attachment member, or ring, 220 on the rear portion 216 of the outer sheath member 210, for attaching one or more lockout safety and warning tags 310 on the safety sheath 200. The safety sheath 200 outer sheath member 210 is adapted for covering the pull ring 120 of the loadbreak connector 100, for example to prevent further access to, and to visually discourage premature re-connection of the loadbreak connector via the loadbreak connector pull ring to a lateral connection contact, the loadbreak connector pull ring otherwise being accessible for pulling the loadbreak connector off of an energized lateral access contact 410 in accordance with safety protocols. The safety sheath 200 outer sheath member 210 is further provided with means 230, 240 for retaining the outer sheath member on the loadbreak connector.

In an embodiment of the safety sheath 200 of the disclosure, the means 230, 240 for retaining the outer sheath member 210 on the loadbreak connector 100 comprises a narrowed channel 225 formed by a collar portion 240 integrated interiorly of the outer sheath member and comprising even narrower leading anterior pinch members 230, the collar portion and the pinch members preferably being integrated with interior walls internally of outer sheath member 210. The narrowed channel 225 is adapted for conforming to a contour portion 140 of the loadbreak connector transverse housing 135 to securely hold the outer sheath member 210 on the loadbreak connector transverse housing.

Thus, the narrowed channel 225, formed by collar portion 240 and anterior pinch members 230, may form a clip 230, 240 for holding the outer sheath member 210 on the loadbreak connector 100. The means for retaining the outer sheath member 210 on the loadbreak connector 100 may do so to the degree of requiring at least four pounds of pulling force to remove the outer sheath member 210 from the loadbreak connector 100. In other words, in operation, it would preferably require a certain amount of pulling force, about four pounds worth, to allow the contour portion 140 of the transverse housing 135 to pass between the pinch members 230 of the clip 230, 240. In this way the safety sheath 200 is held securely onto the loadbreak connector 100, making removal of the same a necessarily deliberate and contemplated act.

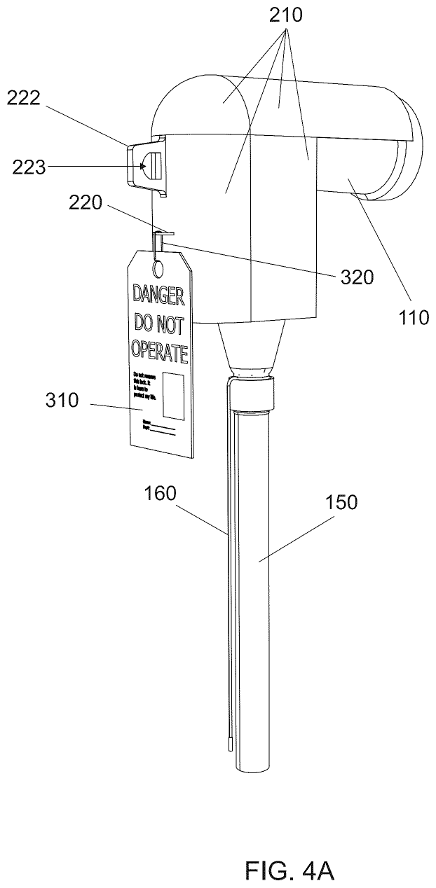

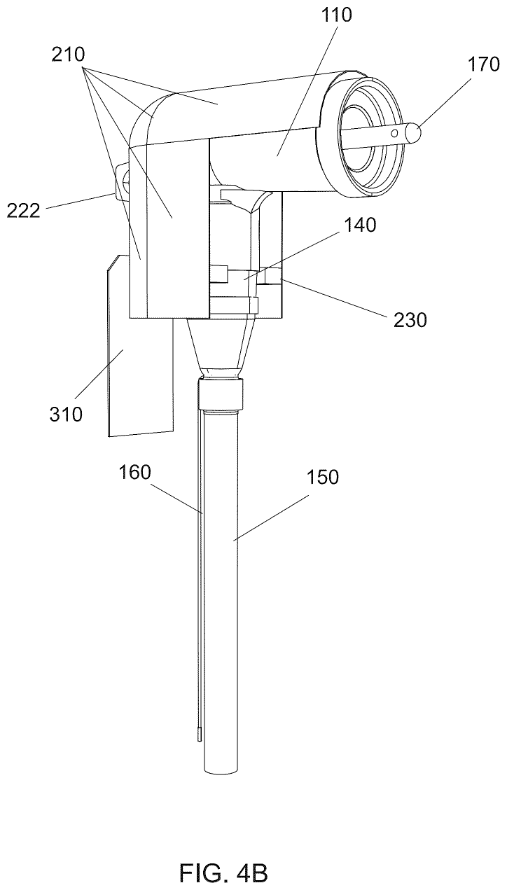

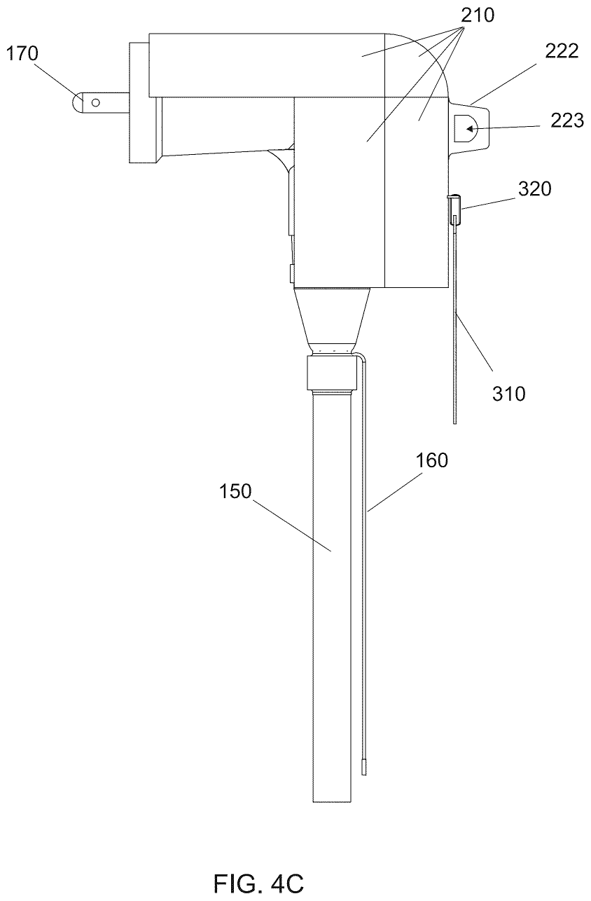

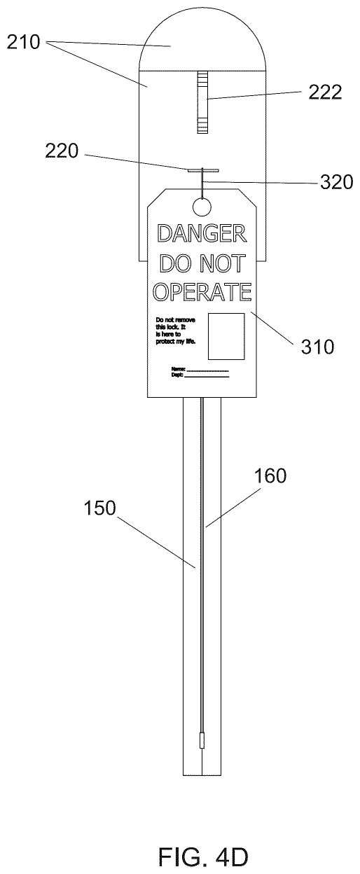

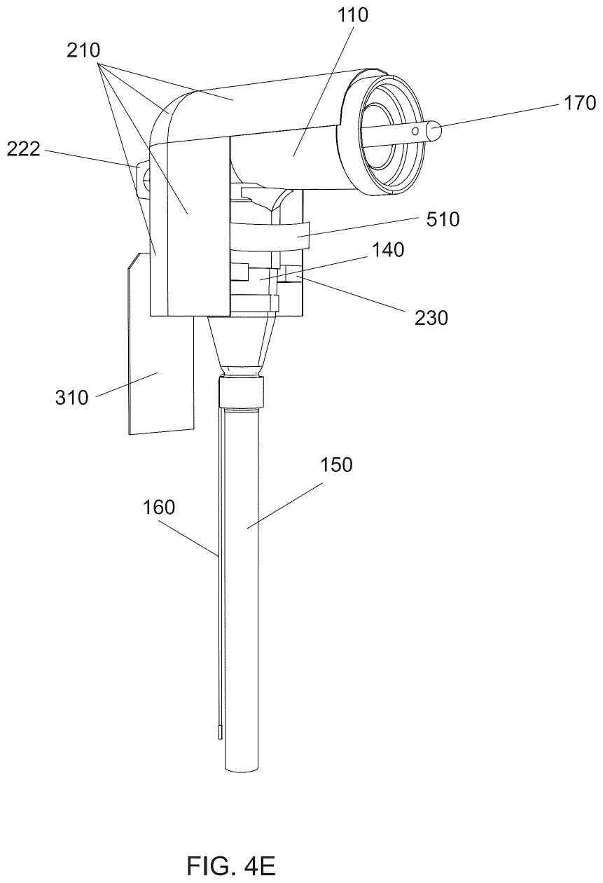

Referring to FIG. 4E, alternative means for retaining, or further retaining, the outer sheath member 210 on the loadbreak connector 100, may comprise a strap 510 secured, as for example with hook and loop technology, or snaps, around the transverse housing 135 body of the loadbreak connector 100.

The safety sheath 200 attachment member, or ring, 220 is adapted for receiving a connector, such as a known locking ring member, for a lockout warning tag 310. The lockout warning tag 310 also may be zip-tied, wire-tied, or otherwise attached to the attachment member 220.

The safety sheath 200 outer sheath member 210 of this aspect and an embodiment of the disclosure may preferably be comprised of one of PVC, PET, and ABS plastic.

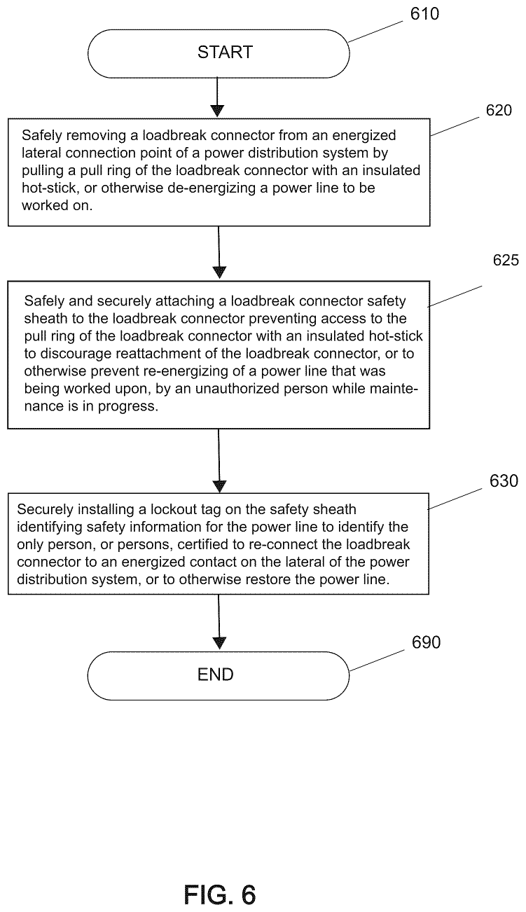

Referring to FIG. 6, in accordance with another aspect of the disclosure, there is provided an improved method of preventing accidental reconnection of a loadbreak connector 100 while following safety protocols to perform maintenance on power lines, comprising the steps of (starting at 610):
A. Step 620—Safely removing a loadbreak connector 100 from an energized lateral connection contact 410 of a power distribution system by pulling a pull ring of the loadbreak connector with an insulated hot-stick, or otherwise de-energizing a power line to be worked on;
B. Step 625—Safely and securely attaching a loadbreak connector safety sheath to the loadbreak connector preventing access to the pull ring of the loadbreak connector with an insulated hot-stick to discourage reattachment of the loadbreak connector to an energized connection contact, or to prevent otherwise re-energizing a power line that was being worked upon, by an unauthorized person while maintenance is in progress; and
C. Step 630—Securely installing a lockout tag on the safety sheath identifying safety information for the power line and the only responsible party certified to re-connect the loadbreak connector to an energized contact of the lateral of the power distribution system, or to otherwise restore power to the line (ending at 690).

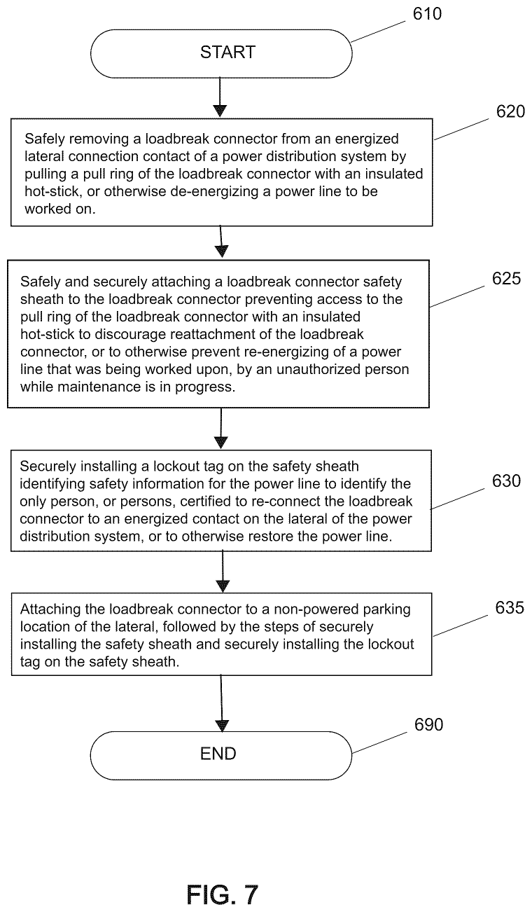

Referring to FIG. 7, in accordance with another embodiment of the method of this aspect of the disclosure, the method further comprises an inserted step of 1) Step 635—attaching the loadbreak connector to a non-powered parking location of the lateral (either between steps A (620) and B (625) above, between steps B (625) and C (630) above, or after step C (630) above).

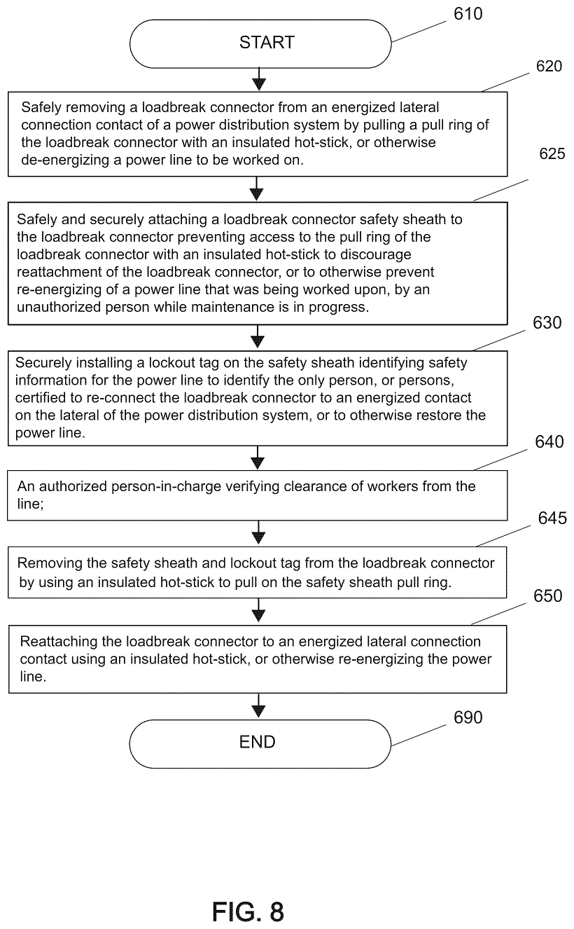

Referring to FIG. 8, in accordance with another aspect of the disclosure, the foregoing methods further comprise the steps of D) Step 640—an authorized person-in-charge verifying clearance of workers from the line by direct personal contact via phone or radio, E) Step 645—safely removing the safety sheath and lockout tag from the loadbreak connector, as by properly using an insulated hot-stick to pull on the safety sheath pull ring, and F) Step 650—reattaching the loadbreak connector to an energized lateral connection contact using an insulated hot-stick for accessing the loadbreak pull ring, or otherwise re-energizing the power line.

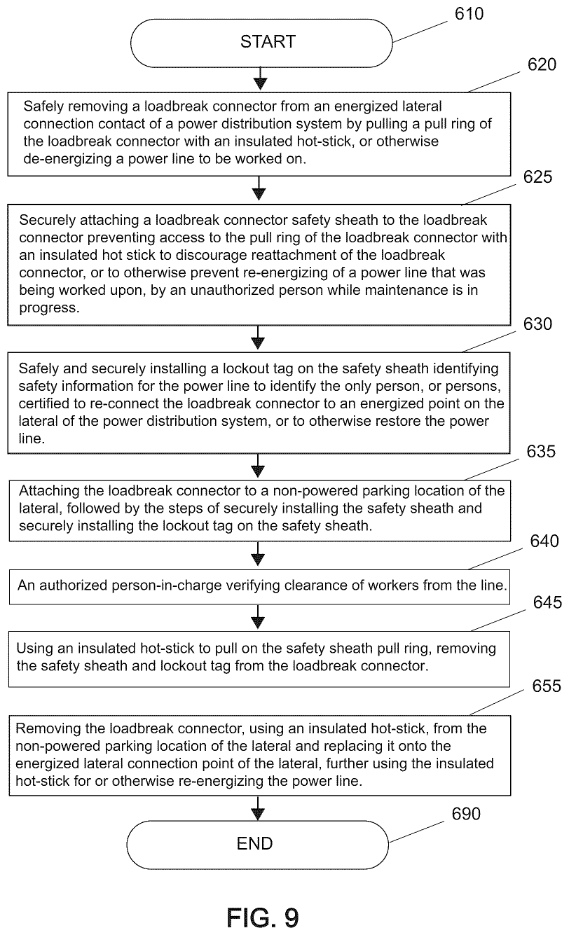

Referring to FIG. 9, in accordance with the another embodiment and further in accordance with this aspect of the disclosure, the method further comprises the steps of D) Step 640—an authorized person-in-charge verifying clearance of workers from the line by direct personal contact via phone or radio, E) Step 645—removing the safety sheath and lockout tag from the loadbreak connector, for example by properly using an insulated hot-stick to pull on the safety sheath pull ring, and F) Step 655—removing the loadbreak connector, using an insulated hot-stick, from the non-powered parking location of the lateral and further using the insulated hot-stick for replacing it onto the energized lateral connection contact of the lateral, or otherwise re-energizing the power line.

The present device and methods are adapted for securely attaching a safety sheath to, and at least partially housing with the safety sheath, a loadbreak connector for connecting to a lateral access contact of a power distribution system, the safety sheath providing its own safety sheath pull ring and a safety sheath attachment member for attaching lockout safety and warning tags. Thus, the device secures the attachment of lockout tags and requires extra steps, encouraging carefully considering the lockout tag information, by only an authorized person in charge, before removal of the safety sheath and lockout tags takes place, and thus further encouraging further careful consideration before reattachment of the loadbreak connector to an energized connection contact of the power distribution system takes place using an insulated hot-stick.

Those skilled in the art will recognize the inventive principles disclosed are not limited to the embodiments disclosed herein, and that various aspects of the disclosed embodiments may be combined to achieve additional embodiments.

In the preceding description, numerous details were set forth. It will be apparent, however, to one skilled in the art, that the present invention may be practiced without some of these specific details. Additionally, one of ordinary skill in the art will recognize the inventive principles disclosed are not limited to the embodiments disclosed herein, and that various aspects of the disclosed embodiments may be combined to achieve yet additional embodiments.

While a preferred embodiment of the present disclosure has been shown and described, it will be apparent to those skilled in the art that many changes and modifications may be made without departing from the claimed subject matter in its broader aspects. It will be appreciated that the appended claims are therefore intended to cover many changes and modifications as may fall within the true spirit and scope of the invention.

What is claimed is:

1. A loadbreak connector safety sheath adapted for partially housing a loadbreak connector for a lateral access contact of a power distribution system and further enabling attachment of lockout safety and warning tags, the safety sheath, comprising:
an outer sheath member adapted for covering a pull ring of the loadbreak connector otherwise accessible for pulling the loadbreak connector off of an energized lateral access contact in accordance with safety protocols;
a safety sheath pull ring for attaching and detaching the safety sheath from the loadbreak connector using a hot-stick; and
a retaining member for retaining said outer sheath member on the loadbreak connector.

2. The safety sheath of claim 1, wherein said retaining member for retaining said outer sheath member on the loadbreak connector comprises a narrowed channel integrated internally of said outer sheath member and adapted for flexibly conforming to a contour portion of the loadbreak connector to securely hold said outer sheath member on the loadbreak connector.

3. The safety sheath of claim 2, wherein said narrowed channel forms a clip for holding said outer sheath member on the loadbreak connector to the degree of requiring at least four pounds of pulling pressure to remove said outer sheath member from the loadbreak connector.

4. The safety sheath of claim 1, further comprising an attachment member adapted for receiving a lockout warning tag.

5. The safety sheath of claim 4, wherein said attachment member comprises an integral ring on a posterior portion of said outer sheath member.

6. The safety sheath of claim 1, wherein the outer sheath member is comprised of one of PVC, PET, and ABS plastic.

7. An improved method of preventing accidental reconnection of a loadbreak connector while following safety protocols to perform maintenance on power lines, comprising the steps of:
a. Safely removing a loadbreak connector from an energized lateral connection contact of a power distribution system by pulling a pull ring of the loadbreak connector with an insulated hot-stick, or otherwise de-energizing a power line to be worked on;
b. Safely and securely attaching a loadbreak connector safety sheath to the loadbreak connector preventing access to the pull ring of the loadbreak connector with an insulated hot-stick to discourage reattachment of the loadbreak connector, or to otherwise prevent re-energizing of a power line that was being worked upon, by an unauthorized person while maintenance is in progress; and
c. Securely installing a lockout tag on the safety sheath identifying safety information for the power line to identify the only person, or persons, certified to re-connect the loadbreak connector to an energized contact on the lateral of the power distribution system, or to otherwise restore the power line.

8. The improved method of claim 7, further comprising the step of attaching the loadbreak connector to a non-powered parking location of the lateral, followed by the steps of safely and securely installing the safety sheath and securely installing the lockout tag on the safety sheath.

9. The improved method of claim 7, further comprising the steps of:
a. An authorized person-in-charge verifying clearance of workers from the line;
b. Safely removing the safety sheath and lockout tag from the loadbreak connector; and
c. Reattaching the loadbreak connector to an energized lateral connection contact using an insulated hot-stick, or otherwise re-energizing the power line.

10. The improved method of claim 8, further comprising the steps of:
a. An authorized person-in-charge verifying clearance of workers from the line;
b. Safely, as by using a hot-stick, removing the safety sheath and lockout tag from the loadbreak connector; and
c. Removing the loadbreak connector, using an insulated hot-stick, from the non-powered parking location of the lateral and replacing it onto the energized lateral connection contact of the lateral, or otherwise re-energizing the power line.

11. A loadbreak connector safety sheath adapted for partially housing a loadbreak connector for a lateral access contact of a power distribution system, the safety sheath, comprising:
an outer sheath member adapted for covering a pull ring of the loadbreak connector otherwise accessible for pulling the loadbreak connector off of an energized lateral access contact in accordance with safety protocols;
a safety sheath pull ring for attaching and detaching the safety sheath from the loadbreak connector using a hot-stick;
a retaining member for retaining said outer sheath member on the loadbreak connector; and
an attachment member on said outer sheath and adapted for receiving a lockout warning tag.

12. The safety sheath of claim 11, wherein said attachment member is attached on a posterior portion of said outer sheath member.

13. The safety sheath of claim 12, wherein said attachment member comprises an integral ring on a posterior portion of said outer sheath member.

14. The safety sheath of claim 13, wherein said retaining member for retaining said outer sheath member on the loadbreak connector comprises a narrowed channel integrated internally of said outer sheath member and adapted for flexibly conforming to a contour portion of the loadbreak connector to securely hold said outer sheath member on the loadbreak connector.

15. The safety sheath of claim 14, wherein said narrowed channel forms a clip for holding said outer sheath member on the loadbreak connector to the degree of requiring at least four pounds of pulling pressure to remove said outer sheath member from the loadbreak connector.

16. The safety sheath of claim 13, wherein the outer sheath member is comprised of one of PVC, PET, and ABS plastic.
